(19) United States
(12) Patent Application Publication
(10) Pub. No.: US 2006/0093982 A1
(43) Pub. Date: May 4, 2006

(54) Method and apparatus for manufacturing and constructing a dental aligner

(76) Inventor: Huafeng Wen, Redwood City, CA (US)

Correspondence Address: MORRISON & FOERSTER LLP, 755 PAGE MILL RD, PALO ALTO, CA, 94304-1018, US

(21) Appl. No.: 10/979,497

(22) Filed: Nov. 2, 2004

(51) Int. Cl. A61C 3/00

(52) U.S. Cl. 433/6

(57) ABSTRACT

A method produces a physical dental aligner. The method includes producing a digital dental aligner model suitable for CNC based manufacturing based on the digital dental arch model and segmenting the digital dental aligner model into a plurality manufactuable digital components. Aligner components are produced using Computer Numerical Control (CNC) based manufacturing in accordance with the digital aligner components and subsequently assembled to form the physical dental aligner.

### CROSS-REFERENCES TO RELATED INVENTIONS

The present invention is related to concurrently filed U.S. patent application, titled “Method and apparatus for manufacturing and constructing a physical dental arch model” by Huafeng Wen, concurrently filed a U.S. patent application, titled “Producing an adjustable physical dental arch model” by Huafeng Wen, and concurrently filed U.S. patent application, titled “Producing a base for a physical dental arch model” by Huafeng Wen. The disclosure of these related applications are incorporated herein by reference.

### TECHNICAL FIELD

This application generally relates to the field of dental care, and more particularly to a system and a method for manufacturing and constructing a physical dental arch model.

### BACKGROUND

Orthodontics is the practice of manipulating a patient's teeth to provide better function and appearance. In general, brackets are bonded to a patient's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a patient may be fitted with a retainer.

To achieve tooth movement, orthodontists utilize their expertise to first determine a three-dimensional mental image of the patient's physical orthodontic structure and a three-dimensional mental image of a desired physical orthodontic structure for the patient, which may be assisted through the use of x-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, the next step in the treatment (e.g., new bend in the wire, reposition or replace brackets, is head gear required, etc.), and the success of the previous step.

In general, the orthodontist makes manual adjustments to the wire and/or replaces or repositions brackets based on his or her expert opinion. Unfortunately, in the oral environment, it is impossible for a human being to accurately develop a visual three-dimensional image of an orthodontic structure due to the limitations of human sight and the physical structure of a human mouth. In addition, it is humanly impossible to accurately estimate three-dimensional wire bends (with an accuracy within a few degrees) and to manually apply such bends to a wire. Further, it is humanly impossible to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the process success and speed being very much dependent on the orthodontist's motor skills and diagnostic expertise. As a result of multiple wire changes, patient discomfort is increased as well as the cost. As one would expect, the quality of care varies greatly from orthodontist to orthodontist as does the time to treat a patient.

As described, the practice of orthodontic is very much an art, relying on the expert opinions and judgments of the orthodontist. In an effort to shift the practice of orthodontic from an art to a science, many innovations have been developed. For example, U.S. Pat. No. 5,518,397 issued to Andreiko, et. al. provides a method of forming an orthodontic brace. Such a method includes obtaining a model of the teeth of a patient's mouth and a prescription of desired positioning of such teeth. The contour of the teeth of the patient's mouth is determined, from the model. Calculations of the contour and the desired positioning of the patient's teeth are then made to determine the geometry (e.g., grooves or slots) to be provided. Custom brackets including a special geometry are then created for receiving an arch wire to form an orthodontic brace system. Such geometry is intended to provide for the disposition of the arched wire on the bracket in a progressive curvature in a horizontal plane and a substantially linear configuration in a vertical plane. The geometry of the brackets is altered, (e.g., by cutting grooves into the brackets at individual positions and angles and with particular depth) in accordance with such calculations of the bracket geometry. In such a system, the brackets are customized to provide three-dimensional movement of the teeth, once the wire, which has a two dimensional shape (i.e., linear shape in the vertical plane and curvature in the horizontal plane), is applied to the brackets.

Other innovations relating to bracket and bracket placements have also been patented. For example, such patent innovations are disclosed in U.S. Pat. No. 5,618,716 entitled “Orthodontic Bracket and Ligature” a method of ligating arch wires to brackets, U.S. Pat. No. 5,011,405 “Entitled Method for Determining Orthodontic Bracket Placement,” U.S. Pat. No. 5,395,238 entitled “Method of Forming Orthodontic Brace,” and U.S. Pat. No. 5,533,895 entitled “Orthodontic Appliance and Group Standardize Brackets therefore and methods of making, assembling and using appliance to straighten teeth”.

Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the arch is described in U.S. Pat. Nos. 5,342,202 and 5,340,309.

Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

The key to efficiency in treatment and maximum quality in results is a realistic simulation of the treatment process. Today's orthodontists have the possibility of taking plaster models of the upper and lower arch, cutting the model into single tooth models and sticking these tooth models into a wax bed, lining them up in the desired position, the so-called set-up. This approach allows for reaching a perfect occlusion without any guessing. The next step is to bond a bracket at every tooth model. This would tell the orthodontist the geometry of the wire to run through the bracket slots to receive exactly this result. The next step involves the transfer of the bracket position to the original malocclusion model. To make sure that the brackets will be bonded at exactly this position at the real patient's teeth, small templates for every tooth would have to be fabricated that fit over the bracket and a relevant part of the tooth and allow for reliable placement of the bracket on the patient's teeth. To increase efficiency of the bonding process, another option would be to place each single bracket onto a model of the malocclusion and then fabricate one single transfer tray per arch that covers all brackets and relevant portions of every tooth. Using such a transfer tray guarantees a very quick and yet precise bonding using indirect bonding.

U.S. Pat. No. 5,431,562 to Andreiko et al. describes a computerized, appliance-driven approach to orthodontics. In this method, first certain shape information of teeth is acquired. A uniplanar target arcform is calculated from the shape information. The shape of customized bracket slots, the bracket base, and the shape of the orthodontic archwire, are calculated in accordance with a mathematically-derived target archform. The goal of the Andreiko et al. method is to give more predictability, standardization, and certainty to orthodontics by replacing the human element in orthodontic appliance design with a deterministic, mathematical computation of a target archform and appliance design. Hence the '562 patent teaches away from an interactive, computer-based system in which the orthodontist remains fully involved in patient diagnosis, appliance design, and treatment planning and monitoring.

More recently, Align Technologies began offering transparent, removable aligning devices as a new treatment modality in orthodontics. In this system, an impression model of the dentition of the patient is obtained by the orthodontist and shipped to a remote appliance manufacturing center, where it is scanned with a CT scanner. A computer model of the dentition in a target situation is generated at the appliance manufacturing center and made available for viewing to the orthodontist over the Internet. The orthodontist indicates changes they wish to make to individual tooth positions. Later, another virtual model is provided over the Internet and the orthodontist reviews the revised model, and indicates any further changes. After several such iterations, the target situation is agreed upon. A series of removable aligning devices or shells are manufactured and delivered to the orthodontist. The shells, in theory, will move the patient's teeth to the desired or target position.

U.S. Pat. No. 6,699,037 Align Technologies describes an improved methods and systems for repositioning teeth from an initial tooth arrangement to a final tooth arrangement. Repositioning is accomplished with a system comprising a series of appliances configured to receive the teeth in a cavity and incrementally reposition individual teeth in a series of at least three successive steps, usually including at least four successive steps, often including at least ten steps, sometimes including at least twenty-five steps, and occasionally including forty or more steps. Most often, the methods and systems will reposition teeth in from ten to twenty-five successive steps, although complex cases involving many of the patient's teeth may take forty or more steps. The successive use of a number of such appliances permits each appliance to be configured to move individual teeth in small increments, typically less than 2 mm, preferably less than 1 mm, and more preferably less than 0.5 mm. These limits refer to the maximum linear translation of any point on a tooth as a result of using a single appliance. The movements provided by successive appliances, of course, will usually not be the same for any particular tooth. Thus, one point on a tooth may be moved by a particular distance as a result of the use of one appliance and thereafter moved by a different distance and/or in a different direction by a later appliance.

The individual appliances will preferably comprise a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the patient, certain of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step.

The fabrication of aligners by Align Technologies utilizes stereo lithography process as disclosed in U.S. Pat. Nos. 6,471,511 and 6,682,346. Several drawbacks exist however with the stereo lithography process. The materials used by stereo lithography process may be toxic and harmful to human health. Stereo lithography process builds the aligner layer by layer by layer, which may create room to hide germs and bacteria while it is worn by a patient. Furthermore, stereo lithography process used by Align Technology also requires a different aligner mold at each stage of the treatment, which produces a lot of waste and is environmental unfriendly. There is therefore a long felt need for a practical, effective and efficient methods to produce a dental aligner.

### SUMMARY OF THE INVENTION

The present invention has been devised to substantially eliminate the foregoing problems and is to provide methods and apparatus to manufacture and construct the physical dental arch model. Implementations of the system may include one or more of the following.

In one aspect, the present invention relates to a method for producing a physical dental aligner, comprising:

producing a digital dental aligner model suitable for CNC based manufacturing based on the digital dental arch model;

segmenting the digital dental aligner model into a plurality manufactuable digital components;

producing aligner components using Computer Numerical Control (CNC) based manufacturing in accordance with the digital aligner components; and

assembling the aligner components to form the physical dental aligner.

In another aspect, the present invention relates to a system for producing a physical dental aligner, comprising:

a computer processor capable of producing a digital dental aligner model and segmenting the digital dental aligner model into a plurality of digital aligner components suitable for CNC based manufacturing; and

an apparatus capable of fabricating aligner components in accordance with the digital aligner components, wherein the aligner components can be assembled to form the physical dental aligner.

In yet another aspect, the present invention relates to a physical dental aligner assembled from a plurality of aligner components, comprising:

a plurality of aligner components produced by Computer Numerical Control (CNC) based manufacturing in response to digital aligner components segmented from a three-dimensional (3D) digital dental aligner model.

Implementations of the system may include one or more of the following. A method for producing a physical dental aligner includes producing a digital dental aligner model suitable for CNC based manufacturing based on the digital dental arch model, segmenting the digital dental aligner model into a plurality manufactuable digital components, producing aligner components using Computer Numerical Control (CNC) based manufacturing in accordance with the digital aligner components, and assembling the aligner components to form the physical dental aligner. The physical dental aligner can include a shell that comprises an outer surface and at least inner surface that is capable of aligning one or more teeth. The shell can comprise multiple layers. The shell can comprise varying thicknesses in different areas that is capable of producing forces to render predetermined teeth movement. The method can further comprise smoothening the outer surface and the one or more inner surfaces in the digital dental aligner model to produce a smoothened digital dental aligner model. The method can further comprise producing a digital dental aligner model based on a digital dental arch model. The method can further comprise automatically assembling the aligner components using a robot arm to form the physical dental aligner. The aligner components can include features that permit the aligner components to be assembled into the physical dental aligner. The features can include one or more of registration slots, a pin, a notch, a protrusion, a hole, an interlocking mechanism, a jig, and a pluggable or an attachable feature. The method can further comprise attaching or sealing the aligner components into each other to form the physical dental aligner. The method can further comprise assembling the aligner components in a predetermined sequence to form the physical dental aligner. The method can further comprise polishing or retouching the assembled aligner components to form the physical dental aligner. The CNC based manufacturing includes one or more of milling, stereo lithography, laser machining, molding, and casting. The physical dental aligner comprises a material selected from the group consisting of plastics, polymers, urethane, epoxy, plaster, stone, clay, acrylic, metals, wood, paper, ceramics, and porcelain. The physical dental aligner comprises surface textures that simulate the cosmetic appearance of teeth. The physical dental aligner comprises a multiple layers each comprising the same or different materials.

Implementations of the system may include one or more of the following. A physical dental aligner assembled from a plurality of aligner components includes a plurality of aligner components produced by Computer Numerical Control (CNC) based manufacturing in response to digital aligner components segmented from a three-dimensional (3D) digital dental aligner model. The physical dental aligner can further comprise physical features associated with the aligner components that permit the aligner components to be assembled into the physical dental aligner. The features can include one or more of a pin, a notch, a protrusion, a hole, an interlocking mechanism, a jig, and a pluggable or an attachable feature.

Embodiments may include one or more of the following advantages. The present invention provides practical methods and system for making a dental aligner. A digital dental aligner model is developed based on a digital dental arch model. The digital dental aligner model is then segmented down to small manufacturable aligner components that can be readily handled by automated machining such as computer numerical control (CNC) based milling. Features are added to the aligner components to allow them be attached, plugged or locked into each other. The aligner components manufactured can be assembled to construct a dental aligner for various dental applications, e.g. retainers, mouth guard. The dental aligner can be assembled by from segmented aligner components that can individually be manufactured by automated, precise numerical manufacturing techniques.

A further advantage of the present invention is that the manufacturability of the aligner components can be simulated, verified and refined if necessary prior to manufacturing. As a result, complex aligner shapes that cannot be made can now be practically manufactured. Waste and cycle times are reduced in the process from design, testing, pilot, to production.

Simplicity is another advantage of the disclosed system and methods. The aligner components can be attached to each other and/or onto a base. The assembled aligner specifically corresponds to the patient's arch. There is no need for complex and costly mechanisms such as micro-actuators for adjusting multiple degrees of freedom for each tooth component.

The aligner components can be pre-fabricated similar to LEGO blocks having standard registration and attaching features for assembling. The aligner components can be automatically assembled by robotic arms under computer control. The aligner components can be separated, repaired or replaced, and reassembled after the assembly.

The described methods and system is simple to make and easy to use. The physical aligner components can include a shell have multiple layers. The outer surface of the shell can be polished and retouched to simulate the aesthetic appearance of a patient's teeth. The inner surface is capable of aligning a patient's teeth.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 is a flow chart for producing a physical aligner in accordance with the present invention.

FIG. 2 illustrates the smoothening of the digital aligner model in preparation for a CNC based manufacturing of physical aligner in accordance with the present invention.

FIG. 3 illustrates the segmentation of digital aligner model into segmented components suitable for CNC based manufacturing in accordance with the present invention.

FIGS. 4a-4d illustrate the segmentation of an inter-proximal region by removing a space around the inter-proximal region and replacing it by a wedge.

FIGS. 5a-d illustrates aligner components comprising features that allow them to assembled to form an aligner.

FIG. 6 illustrates an aligner assembled from a plurality of aligner components each comprising features that assist the assembling.

### DESCRIPTION OF INVETION

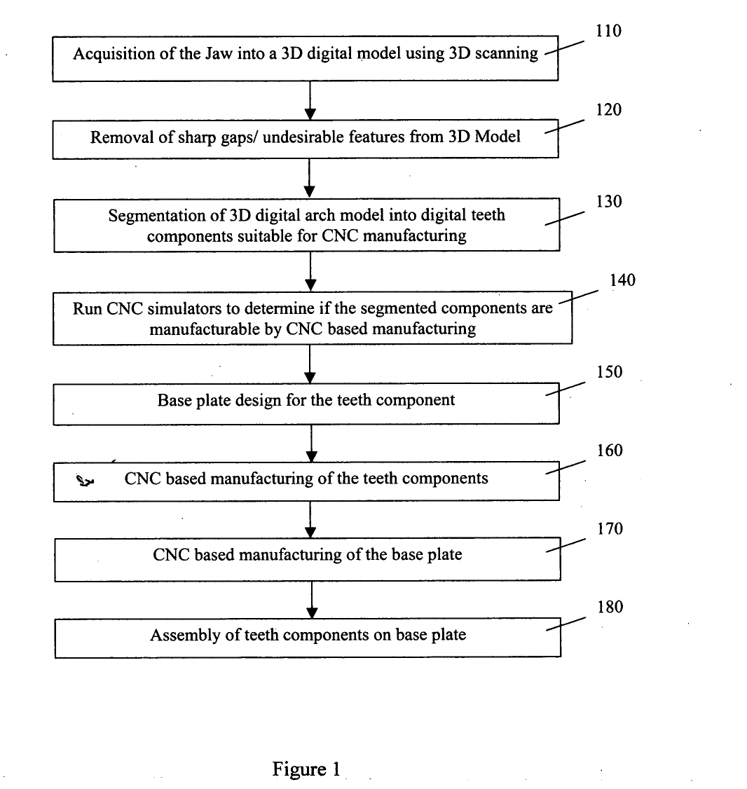

FIG. 1 illustrates the process of producing a dental aligner in accordance with the present invention. In the present application, the term “dental aligner” refers to a dental device for correcting malocclusion. First, a three dimensional (3D) digital model is acquired from a patient's arch in step 110. The digital model can be obtained by 3D scanning of a cast produced from the patient's arch. The digital model includes a mesh of points in three dimensions that define the surfaces of an entire or a large portion of an upper or lower arch. Details of obtaining a digital model of an arch are disclosed in above referenced and currently filed U.S. patent application titled “Producing a base for a physical dental arch model” by Huafeng Wen, the content of which is incorporated herein by reference.

Next, in step 120, the digital dental arch model is smoothened by computer processing. A software takes the digital dental arch model as input. One or more criteria for the degree of smoothness can also be provided by a user. Undesirable features such as sharp gas and divots are removed from the digital dental arch model.

The criteria for the degree of smoothness can be required by the specific dental applications. The plastic aligners for example cannot reach into the gaps between the teeth. In addition, it is also undesirable to have aligner to have fine features inside the gaps because that could potentially create resistance to desired tooth movement in a orthodontics treatment procedure.

The criteria for the degree of smoothness can also be required by type of the tools used to manufacture the aligner components as described below. In the present invention, Computer Numerical Control or CNC based manufacturing refers to the automated and computer controlled machining. The most basic function of a CNC machine is automatic, precise, and consistent motion control. All forms of CNC equipment have two or more directions of motion, called axes. These axes can be precisely and automatically positioned along their lengths of travel. The two most common axis types are linear (driven along a straight path) and rotary (driven along a circular path). Instead of causing motion by manually turning cranks and handwheels as is required on conventional machine tools, CNC machines allow motions to be actuated by servomotors under control of the CNC, and guided by the part program. Generally speaking, the motion type (rapid, linear, and circular), the axes to move, the amount of motion and the motion rate (feed rate) are programmable with almost all CNC machine tools. In the present invention, in addition to CNC based milling, the CNC based manufacturing is also compatible with other computer numerical controlled manufacturing processes such as stereolithography, laser machining, molding as well as other types of CNC based machining.

For manufacturing a physical dental arch model, however, the drill bit in CNC based milling is usually too big to reach into the gaps and holes in a dental arch model. CNC milling is usually around one axis, which makes it difficult to machine the complex shapes within the gaps between teeth. CNC based milling also has limitations in accuracy and repeatability between different stages of milling.

Several techniques have been used to remove the gaps in the digital dental arch model to produce a smoothened digital dental arch model:

1. Boolean union with primitive 3D objects. Graphics Constructive Solid Geometry primitives or self developed predefined geometries can be inserted into the gaps in the digital dental arch model and then combine with the original 3D digital mesh.

2. Extrusion. The surfaces near the gaps are extruded to fill the gaps in the original 3D digital mesh.

3. Geometry modification by moving vertices. Sharp gaps can be closed by specifying the desired boundaries and modifying the mesh to the desired boundaries in the problem regions.

4. Subdivision of surfaces and movement. Similar to Technique 3, the dental arch surfaces are subdivided in the regions of surface modification for greater smoothness and continuity.

5. Convex hull creation of sub parts to be used as filling objects in the gaps. The gap regions are first located and the points defining edges of the sharp gaps are identified. A convex hull is computed based on these points. The convex hull is joined with the original mesh to fill the gaps using Boolean union.

6. Using parametric surfaces to model fill objects that will be used fit in the gaps.

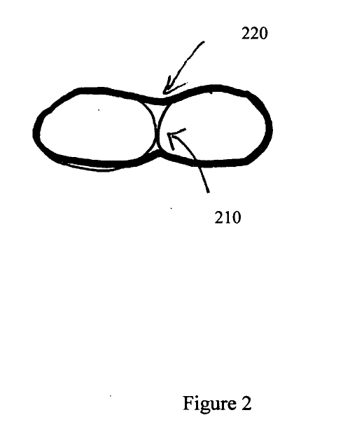

FIG. 2 illustrates the smoothening effects of the gap filling by comparing the surfaces 210 of before gap fillings and the surfaces 220 after the gap fillings.

A simulation can be conducted using the smoothened the digital dental arch model as input to check and verify the smoothness of the digital dental arch model. The simulation can be run using a simulator software in response to the smoothness criteria required by the manufacturing process such as CNC based milling or the dental applications. Refinement ad smoothening iterations may be called for if the smoothness criteria are not completely satisfied.

A digital aligner model is next developed based on the digital dental arch model in Step 130. The digital aligner model comprises inner surfaces and outer surfaces. Since the inner surfaces of the aligner will be in contact with the outer surface of the patient's teeth, the inner surfaces of the digital aligner model approximately follow the contours of the outer surface of the digital dental arch model, so that the dental aligner will snap on the arch. Moreover, the inner and outer surfaces of digital aligner are designed to various shapes and thickness to apply the right forces to achieve the movement of the teeth in accordance with a treatment plan.

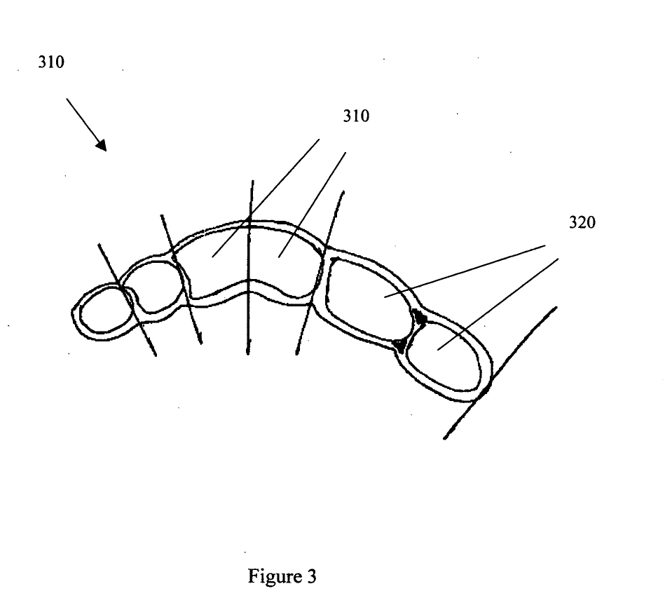

Next, in Step 140, the digital aligner model are segmented into digital aligner components suitable for CNC manufacturing. A typical aligner in the digital aligner model includes an upper or lower aligner respectively for the upper and lower arch or a portion of an arch comprising a plurality of teeth. An aligner 300 is shown in FIG. 3. The aligner components 310,320 can correspond to a portion of a tooth, a whole individual tooth, or sometimes a segment of arch including several teeth.

The criteria for the size, location, and the number of aligner components are based on both orthodontic needs and manufacturing requirements. The orthodontic criteria require the tracking of how the original locations of the aligner components and which components can be moved together as a group, which aligner components must be moved independently, and which teeth cannot be moved.

The manufacturing requirements relate mainly to the manufacturability of the digital aligner components, which usually supersedes the orthodontic criteria. For example, a single tooth can be divided into multiple components to make its model manufacturable. The segmented digital components can be evaluated by a simulator software to verify their manufacturability by a specific manufacture process such as CNC based milling, which may suggest refinement in the size, location, and numbers of the segmentation. The simulation can also include an evaluation and estimation of the physical strength after the assembly, as described below, to determine if the assembled aligner components are strong enough to withstand the physical forces in a pressure forming process.

In one embodiment, the digital aligner model can be smoothened during the segmentation. Different segmented digital components may receive different types or degree of smoothening so that the smoothening is tailored to the segments and manufacturing requirements.

An advantage of the present invention is that an aligner model is segmented to small manufacturable aligner components that can be manufactured by automated, precise numerical manufacturing techniques.

A further advantageous feature of the present invention is that the manufacturability of the digital components are simulated, verified and refined if necessary prior to manufacturing. As a result, complex aligner shapes that cannot be made can now be practically manufactured. Waste and cycle times are reduced in the process from design, testing, pilot, to production.

In step 150, features are added to the aligner components to assist the assembling of the aligner components to form an aligner. The features may include a pin, a registration slot, a notch, a protrusion, a hole, an interlocking mechanism, a socket, a jig, and a pluggable or an attachable feature. The adjacent manufactured aligner components may include matching male (e.g. mushroom, push pins) and female features (e.g. hole, notches etc.) for attachment. The male and female features can be fabricated for example by casting mold that include female and male matching features in the mold, each responsible for making respective male and female features. The adjacent aligner components can attached together by simply pushing male feature into the female feature, for example, by pressing a pushpin into a receiving hole.

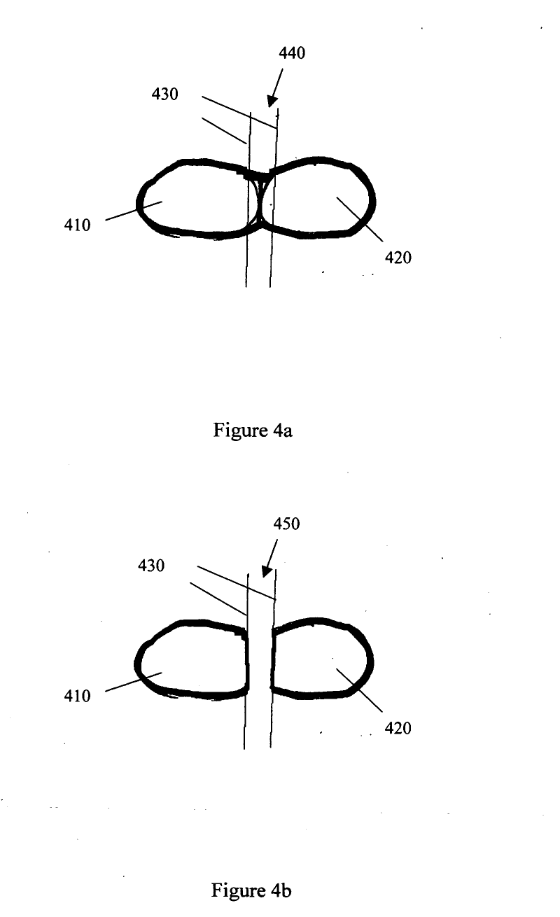

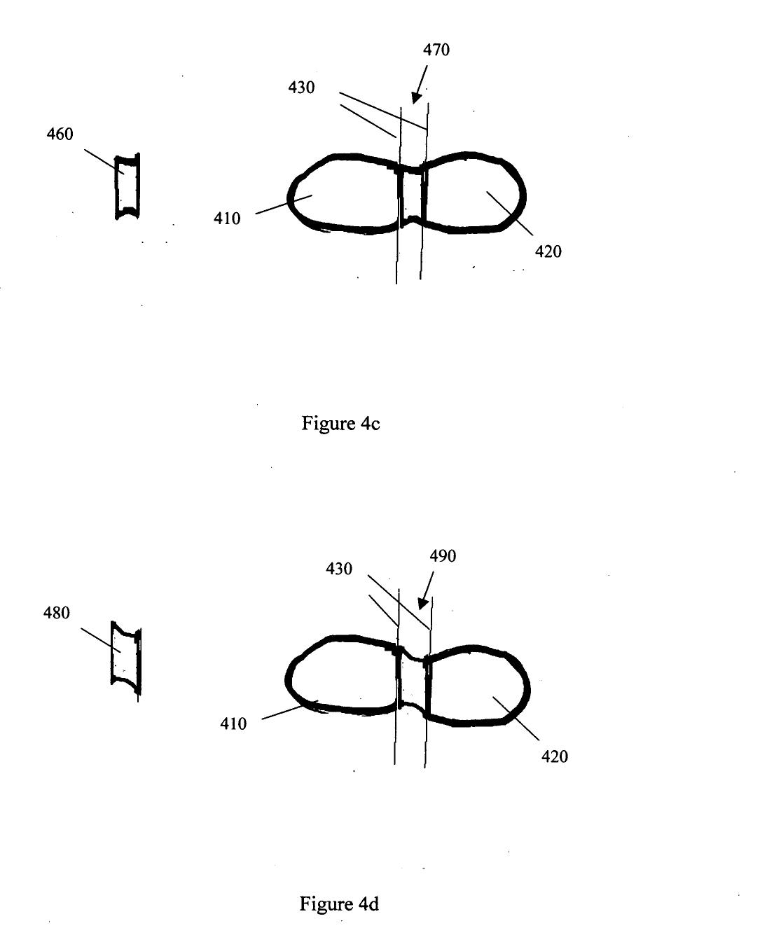

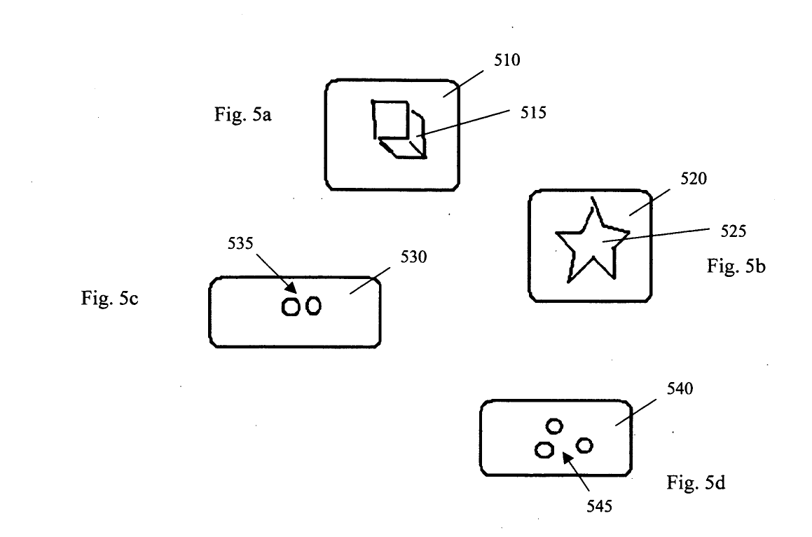

In another embodiment, special care needs to be applied to the inter-proximal regions in segmenting arch into digital components. In many cases, the inter-proximal regions involve such complexity and details that CNC based manufacturing such as cutting or milling cutting can result in losing details. As shown in FIGS. 4a and 4b, an inter-proximal region 440 is removed between a tooth model 410 and a tooth model 420 along the lines 430. This can be achieved by data processing over the digital dental arch model. A thin gap 450 is formed between tooth model 410 and tooth model 420.

A wedge 460, shown in FIG. 4c, is then made using CNC based manufacturing technique similar to other manufacturable digital components. The wedge 470 can be inserted into the gap 450 to complete the digital tooth arch model. The wedge making and insertion can take into account of the movement of the tooth models 410, 420 during the orthodontic treatment. As shown FIG. 4d, the wedge 480 is made to be slightly sheared. The wedge 490 inserted between the tooth models 410, 420 can therefore induce a relative movement between the tooth models 410, 420. In general the relative movement can include translational and directional adjustment in different degrees of freedoms. The resulted tooth arch model can then be used to made dental aligners.

FIGS. 5a, 5b, 5c and 5d illustrate examples of the features in the aligner components 510,520,530,540. The features 515,525,535,545 allow the aligner components 510,520,530,540 to be attached to each other to form a whole or part of a physical aligner. FIG. 5a shows a feature 515 having a cubic base for a aligner component 510. FIG. 5b shows a feature 525 having a star-shaped base for a aligner component 520. The star-shaped base defines unique orientation when aligner component 520 is assembled with another aligner component. FIGS. 5c and 5d show features 535 and 545 respectively comprising two and three pins in the aligner components 530 and 540. The two pins ensure uniquely defined orientation when aligner component 530 is assembled with another aligner component. Similarly, the three pins in feature 545 ensure unique configuration when aligner component 540 is assembled with another aligner component.

The aligner components 310,320 are manufactured in Step 160 using CNC based manufacturing techniques. The segmented digital aligner components are provided to as CNC objects input to a CNC machine. The aligner components 310,320 are manufactured individually. In the disclosed methods and systems, the precision and yield of the CNC based manufacturing are high because manufacturability has been considered and verified as part of the designs of the aligner components. Common materials for the aligner components include polymers, urethane, epoxy, plastics, plaster, stone, clay, acrylic, metals, wood, paper, ceramics, and porcelain. A mechanism may be required to hold the components in place during the milling process.

In one embodiment, the aligner is milled out of a plastic block in accordance with digital aligner model. The milled out portion can be a portion of a tooth or a group of teeth. The inner hollow portion of the partially milled plastic block is then filled up with a soft holding material under heating. The holding material is soft at elevated temperatures and is hardened at room temperature. The holding material forms a handle after it cools off to room temperature. The partially milled plastic block can be held from outside while it is milled by CNC based manufacturing. An aligned is produced after machining. The holding material is subsequently removed by heating. The holding material can be wax, silicon, Epoxy or other kind of removable glue.

In another embodiment, the outer portion of the aligner component is first fabricated using CNC based manufacturing out of a plastic block. The partially milled plastic block is then inverted and filled with a holding material that has been softened under heating. The holding material wraps the top portion of the partially milled plastic block. The material is hardened after cooling off and firmly grabs the partially milled plastic block in place. Then the inner portion of the aligner arch can be machined while the partially milled plastic block is held at the hardened holding material. An aligned is produced after machining. The holding material is finally removed by heating. The holding material can be wax, silicon, Epoxy or other kind of removable glue.

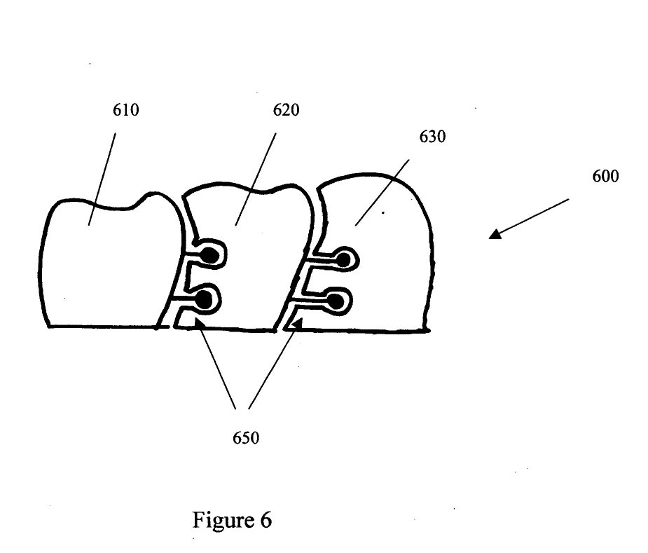

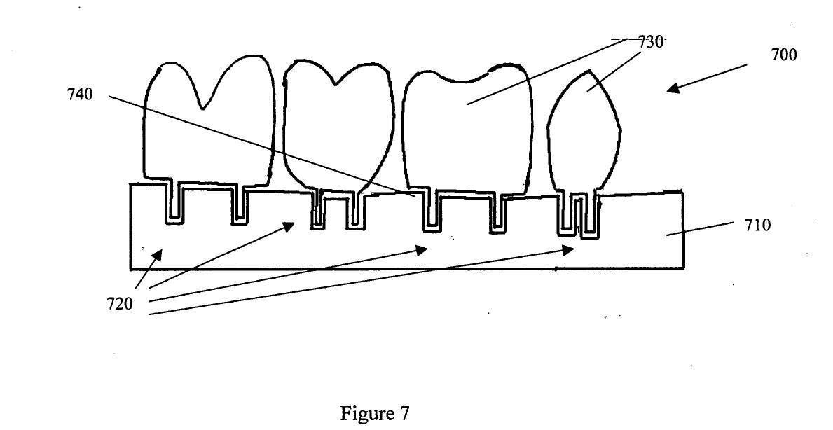

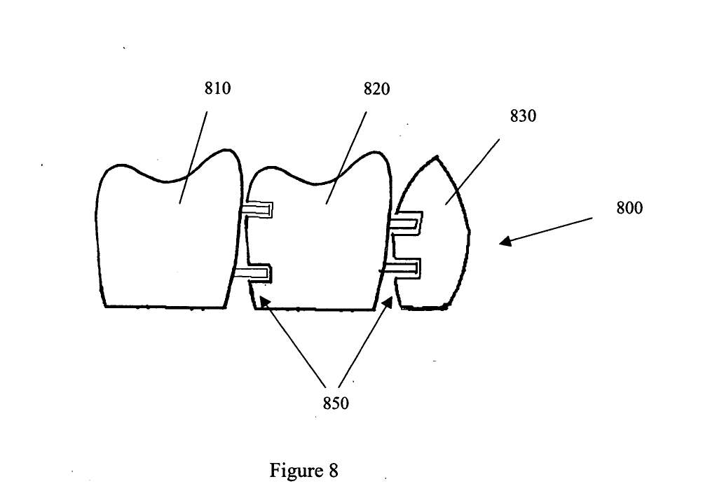

In yet another embodiment, a special clamp can also be used to hold the partially milled aligner parts in place while the rest of the aligner is milled using the CNC machine The physical aligner model 600 is assembled in Step 170 by assembling the aligner components. FIG. 6 illustrates how the aligner components 610,520,530 can be assembled to form a whole or a portion of a physical aligner model 600. The different aligner components 610,620,630 can be attached or plugged into each other at joining features 650 that can be pins, registration slot, a notch, etc.

The physical aligners can be used in different dental applications such as dental crown, dental bridge, dental retainer, mouth guard and teeth whitening. For aligner fabrication, for example, each stage of the teeth treatment may correspond a unique physical aligner model. Aligners can be fabricated based on the digital dental arch model as the teeth movement progresses during the treatment. At each stage of the treatment, the desirable teeth positions for the next stage are calculated. A physical aligner model is fabricated using the process described above for modifying teeth positions in Step 180.

In one aspect, the disclosed methods and system allow variable shape and thickness in the aligner designs comparing the prior art systems. Moreover, the disclosed methods and system provides wider range of aligner material selections. Analyses over aligner shape can be conducted done to ensure the optimal shape of aligner to be produced to achieve the desired movements at each stage of the orthodontic treatment. In addition, aligners having optimized shapes can achieve certain movements that the prior art cannot achieve. The aligners can be made thinner and more cosmetic, allowing more comfort in wearing. The manufacturing process is more consistent and easy.

The aligner components can be labeled with unique identifications, and assembled and detached in predetermined sequences. The assembling and detachment can be automated by for example a robotic arm under the control of a computer in accordance with the predetermined sequences.

In one embodiments, the aligner components are assembled in pressure forming. The aligner components may be hollow inside and have outer surfaces that match the digital aligner components to allow proper union of the aligner components.

In another embodiments, the aligner components can be pre-fabricated similar to LEGO blocks. The surfaces of the aligner components may include standard registration and attaching features for them to join together. The LEGO-like aligner components can be automatically assembled by robotic arms under computer control.

In yet another embodiments, the aligner components can be separated and repaired after the assembly. The attaching features between aligner components allow the components to be detached in a sequence. Broken component can be removed, repaired or replaced, followed by re-assembling.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method for producing a physical dental aligner, comprising:
producing a digital dental aligner model suitable for CNC based manufacturing based on the digital dental arch model;
segmenting the digital dental aligner model into a plurality manufactuable digital components;
producing aligner components using Computer Numerical Control (CNC) based manufacturing in accordance with the digital aligner components; and
assembling the aligner components to form the physical dental aligner.

2. The method of claim 1, wherein the physical dental aligner includes a shell that comprises an outer surface and at least inner surface that is capable of aligning one or more teeth.

3. The method of claim 2, wherein the shell comprises multiple layers.

4. The method of claim 2, wherein the shell comprises varying thicknesses in different areas that is capable of producing forces to render predetermined teeth movement.

5. The method of claim 2, further comprising smoothening the outer surface and the one or more inner surfaces in the digital dental aligner model to produce a smoothened digital dental aligner model.

6. The method of claim 1, further comprising:
producing a digital dental aligner model based on a digital dental arch model.

7. The method of claim 1, further comprising
automatically assembling the aligner components using a robot arm to form the physical dental aligner.

8. The method of claim 1, wherein the aligner components include features that permit the aligner components to be assembled into the physical dental aligner.

9. The method of claim 8, wherein the features include one or more of registration slots, a pin, a notch, a protrusion, a hole, an interlocking mechanism, a jig, and a pluggable or an attachable feature.

10. The method of claim 1, further comprising
attaching or sealing the aligner components into each other to form the physical dental aligner.

11. The method of claim 1, further comprising
assembling the aligner components in a predetermined sequence to form the physical dental aligner.

12. The method of claim 1, further comprising
polishing or retouching the assembled aligner components to form the physical dental aligner.

13. The method of claim 1, wherein the CNC based manufacturing includes one or more of milling, stereo lithography, laser machining, molding, and casting.

14. The method of claim 1, wherein the physical dental aligner comprises a material selected from the group consisting of plastics, polymers, urethane, epoxy, plaster, stone, clay, acrylic, metals, wood, paper, ceramics, and porcelain.

15. The method of claim 1, wherein the physical dental aligner comprises surface textures that simulate the cosmetic appearance of teeth.

16. The method of claim 1, wherein the physical dental aligner comprises a multiple layers each comprising the same or different materials.

17. A system for producing a physical dental aligner, comprising:
a computer processor capable of producing a digital dental aligner model and segmenting the digital dental aligner model into a plurality of digital aligner components suitable for CNC based manufacturing; and
an apparatus capable of fabricating aligner components in accordance with the digital aligner components, wherein the aligner components can be assembled to form the physical dental aligner.

18. A physical dental aligner assembled from a plurality of aligner components, comprising:
a plurality of aligner components produced by Computer Numerical Control (CNC) based manufacturing in response to digital aligner components segmented from a three-dimensional (3D) digital dental aligner model.

19. The physical dental aligner of claim 18, further comprising physical features associated with the aligner components that permit the aligner components to be assembled into the physical dental aligner.

20. The method of claim 19, wherein the features include one or more of a pin, a notch, a protrusion, a hole, an interlocking mechanism, a jig, and a pluggable or an attachable feature.
